(19) United States
(12) Patent Application Publication
(10) Pub. No.: US 2025/0186943 A1
(43) Pub. Date: Jun. 12, 2025

(54) PASSIVE AUTOMATIC INJECTOR REACTOR SYSTEM

(71) Applicant: Altect, Inc., Austin, TX (US)

(72) Inventors: Kevin MARR, Austin, TX (US); Jan-Michael CABRERA, Austin, TX (US)

(73) Assignee: Altect, Inc., Austin, TX (US)

(21) Appl. No.: 18/833,822

(22) PCT Filed: Jan. 27, 2023
(86) PCT No.: PCT/US2023/061493

§ 371 Date: Jul. 26, 2024

Related U.S. Application Data
(60) Provisional application No. 63/303,697, filed on Jan. 27, 2022.

(51) Int. Cl. B01D 53/76; B01D 53/88; B01F 23/10; B01F 25/312; B01F 35/71; B01F 35/92; B01F 101/00; H01M 50/317

(52) U.S. Cl. CPC B01D 53/76; B01D 53/885; B01F 23/10; B01F 25/312; B01F 35/712; B01F 35/71805; B01F 35/92; H01M 50/317; B01D 2251/102; B01D 2258/02; B01D 2259/10; B01F 2101/2204

(57) ABSTRACT

Apparatus and associated methods relate to a passive automatic injector reactor system (PAIRS). In an illustrative example, an energy storage enclosure may contain energy storage modules (e.g., batteries) releasing target gas(es) (e.g., toxic, flammable). The PAIRS may, for example, include an injector in fluid communication with the enclosure. The injector may, for example, passively direct target gases released from the enclosure to a mixing area where supplemental gas(es) are entrained with the target gases to create a target gas air mixture that is directed to a reactor. The reactor may, for example, utilize one more chemical, physical, and/or physiochemical processes to convert the target air gas mixture into a processed gas before release. Various embodiments may advantageously prevent fire, explosion, and/or the release of toxic gas from batteries.

### CROSS-REFERENCE TO RELATED APPLICATIONS

This application is a national stage entry of and claims the benefit of PCT Application Serial No. PCT/US2023/061493, titled “Passive Automatic Injector Reactor System,” filed by Kevin Marr, et al. on Jan. 27, 2023, which application claims the benefit of U.S. Application Ser. No. 63/303,67, titled “Fire, explosion, and overpressure for mitigation and venting systems for batteries,” filed by Kevin Marr, et al., on Jan. 27, 2022.

This application incorporates the entire contents of the foregoing application(s) herein by reference.

The subject matter of this application may have common inventorship with and/or may be related to the subject matter of the following: U.S. Provisional Application Ser. No. 63/082,578, titled “Fire and explosion mitigation system for hazardous gasses released during battery failures,” filed by Kevin Marr and Paul Lee on Sep. 24, 2020; and U.S. application Ser. No. 17/448,260, titled “Explosive Environment Neutralization in Chemical Energy Storage,” filed by Kevin Marr and Paul Lee on Sep. 21, 2021.

This application incorporates the entire contents of the foregoing application(s) herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of awarded by.

### TECHNICAL FIELD

Various embodiments relate generally to fire and explosive protection systems.

### BACKGROUND

Batteries are sources of electrical power including one or more electrochemical cells with external connections. Under normal or abnormal operation conditions, the chemicals within the battery may, for example, generate one or more gases.

Batteries provide an alternative to fossil fuels that reduces the global release of greenhouse emissions. Batteries are becoming more prevalent in work settings as governments, consumers, and companies swap to electrically powered devices. The devices may, for example, include electric vehicles, laptops, and/or car batteries.

Batteries may be transported over long distances. Batteries may, for example, be transported across the sea in shipping containers. Batteries may, for example, be transported in trucks. Batteries may, for example, be transported in storage boxes. Batteries may, for example, be stored in warehouses.

### SUMMARY

Apparatus and associated methods relate to a passive automatic injector reactor system (PAIRS). In an illustrative example, an energy storage enclosure may contain energy storage modules (e.g., batteries) releasing target gas(es) (e.g., toxic, flammable). The PAIRS may, for example, include an injector in fluid communication with the enclosure. The injector may, for example, passively direct target gases released from the enclosure to a mixing area where supplemental gas(es) are entrained with the target gases to create a target gas air mixture that is directed to a reactor. The reactor may, for example, utilize one more chemical, physical, and/or physiochemical processes to convert the target air gas mixture into a processed gas before release. Various embodiments may advantageously prevent fire, explosion, and/or the release of toxic gas from batteries.

Various embodiments may achieve one or more advantages. The PAIR system has a passive system for treating target gases released from the batteries that are exposed to high temperatures during transport and/or storage passively. Often during transport, containers may, for example, not have access to an external power supply to treat gases released by the battery. If the target gases are left untreated, the target gases in the enclosure may combust. If the target gases are left untreated, toxic gas contained in the enclosure may, for example, be hazardous to anyone that opens the container. If the target gases are left untreated, the toxic gas and/or flammable gas may leak. Leaking toxic and/or flammable gases may, for example, result in explosion, fire and/or health problems. The PAIR system may, for example, advantageously treat these target gases to prevent discharge of such gases and so, for example, my advantageously prevent explosion, fire, and/or exposure to toxic gas.

The PAIR system may, by way of example and not limitation, be used in shipping containers containing batteries without an external power source, because it is powered by the chemical reaction of the gas released from the batteries. The PAIR system may, for example, be used in electrical vehicles. The PAIR system may, for example, be used in containers of consumer products that contain batteries. The consumer products may, for example, include laptops. The consumer products may, for example, include gaming consoles. The PAIR system may, for example, be used in storage areas such as, by way of example and not limitation, warehouses. The PAIR system may, for example, be used in small enclosures containing batteries. The PAIR system may, for example, be used in transport trucks for interstate travel.

Various embodiments may achieve one or more advantages. For example, the reactor may include porous media substrates coated in catalytic material that promotes oxidation, reaction, neutralization, conversion, and/or absorption of the toxic gases. The reaction may, for example, be exothermic. The porous media substrates may, for example, include ceramic monoliths, ceramic foams, and pellets made of alumina, zirconia, or other suitable ceramics. Metallic foams may, for example, be used. The catalytic matier include but is not limited to noble metal catalysts, such as platinum, gold, silver, palladium, and non-noble metallic elements, such as iron, chrome, copper, manganese, and oxides of these elements, and metal organic frameworks (MOFs). The oxidation process may, for example, neutralize the toxic gas into a processed gas.

Various embodiments may achieve one or more advantages. For example, some embodiments may include a catalytic reactor. The reactor may, for example, be sufficiently heated in from the mixture of the target gas and surround air. The target gas air mixture temperature may, for example, have a temperature greater than the light-off temperature and/or the temperature required for the catalytic activation needed to treat the gas in the reactor.

The light off temperature can vary upon the catalyst material and the concentration of the target gas. By way of example, but not in limitation, temperatures from the reaction may range from room temperature to 500 degrees Celsius.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary passive automatic injector reactor (PAIR) system employed in an illustrative use-case scenario.

FIG. 2A is a block diagram depicting an exemplary PAIR system.

FIG. 2B depicts an exemplary schematic of an exemplary PAIR system.

FIG. 2C depicts an exemplary illustrative scenario of an exemplary PAIR system.

FIG. 2D depicts a plurality of exemplary PAIR system used in a single enclosure.

FIG. 3 is a block diagram depicting an exemplary injector system.

FIG. 4A is an exemplary diagram 400 of the mixing chamber that combines the reactive gas and the target gases.

FIG. 4B depicts an exemplary schematic of a mixing area system.

FIG. 4C depicts an exemplary stacked mixing tube configuration.

FIG. 4D depicts an exemplary concentric mixing tube 420 used with a multi-stage reactor.

FIG. 5A depicts an exemplary flapper valve schematic.

FIG. 5B depicts an exemplary ball valve schematic and flow diagram.

FIG. 5C depicts an exemplary membrane valve schematic and flow diagram.

FIG. 5D depicts a second exemplary membrane valve schematic and flow diagram.

FIG. 5E depicts an exemplary umbrella valve schematic and flow diagram.

FIG. 6A depicts an exemplary PAIR system block diagram configuration.

FIG. 6B. depicts an exemplary reactor block diagram of a PAIR system such that the reactor heats up the target gas as it flows from the enclosure to the injector.

FIG. 6C depicts an exemplary schematic of a PAIR system such that the reactor heats up the target gas as it flows from the enclosure to the injector.

FIG. 7A depicts an exemplary PAIR system block diagram configuration such that the reactive gas cools the reactor as it flows in.

FIG. 7B depicts an exemplary schematic of a PAIR system configuration such that the reactive gas cools the reactor as it flows in.

FIG. 8 depicts an exemplary block diagram of a PAIR system with a supplemental oxygen supply configuration.

FIG. 9 depicts an exemplary method for configuring the PAIR system to passively direct target gas and entraps reactive gases.

FIG. 10 depicts exemplary data points with respect to the reactor's temperature over time.

FIG. 11 depicts exemplary data points 1100 that shows the entrainment ratio for various types of injector nozzles and mixing tube designs as a function of venting flow rate.

FIG. 12 depicts exemplary data points with respect to the target gas inflow compared to the reactive gases entrapped.

FIG. 13 depicts exemplary data points with respect to the internal pressure of the container. Like reference symbols in the various drawings indicate like elements.

### DETAILED DESCRIPTION OF ILLUSTRATIVE EMBODIMENTS

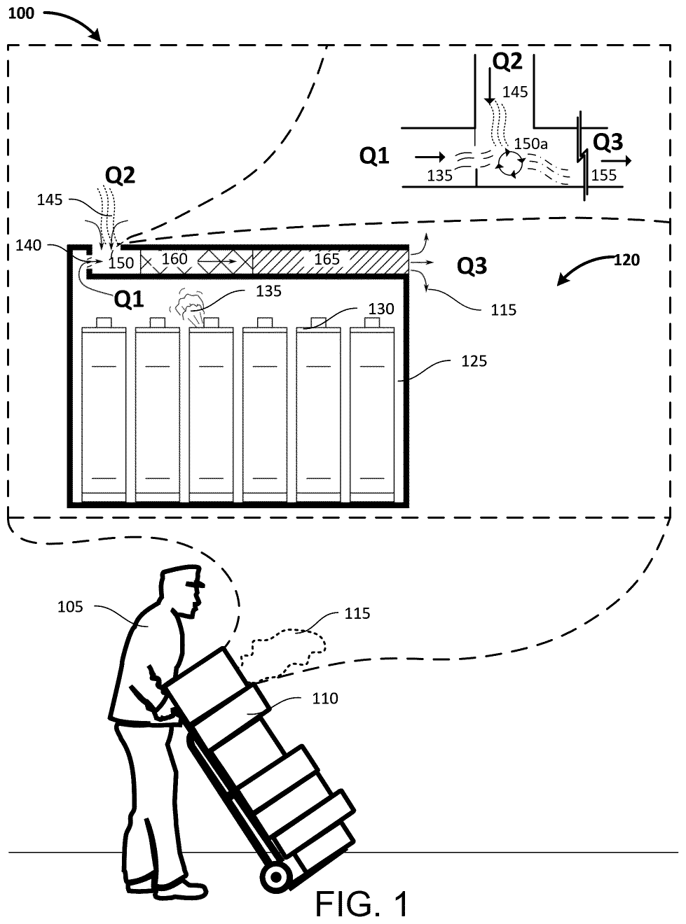

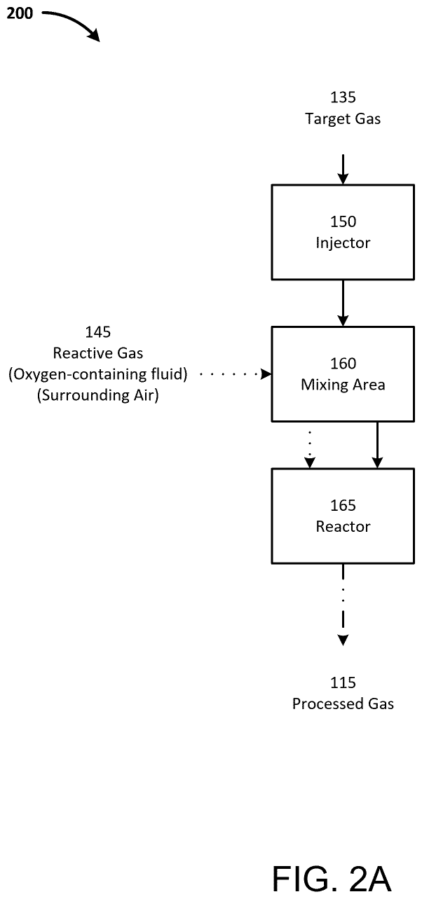

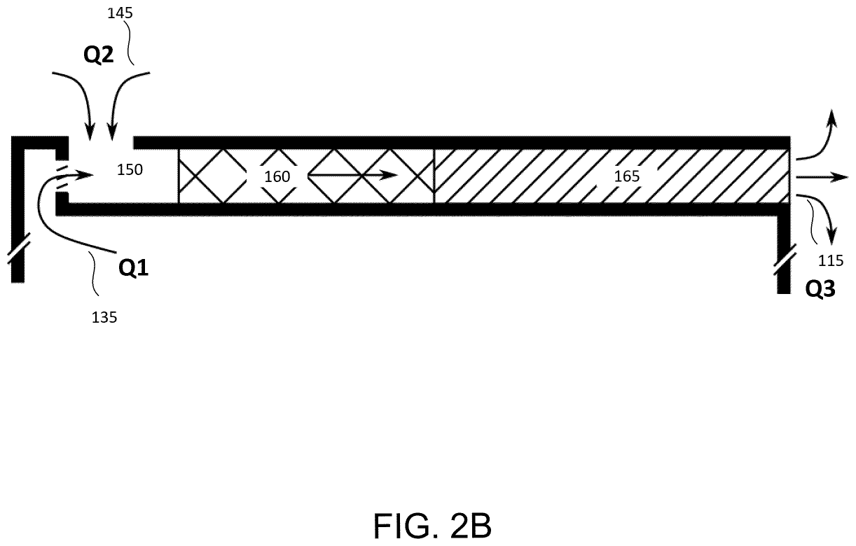

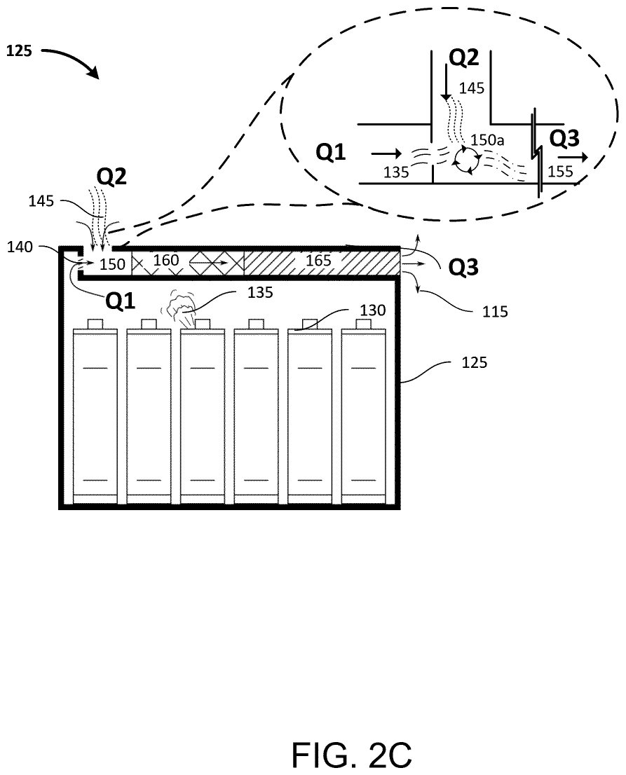

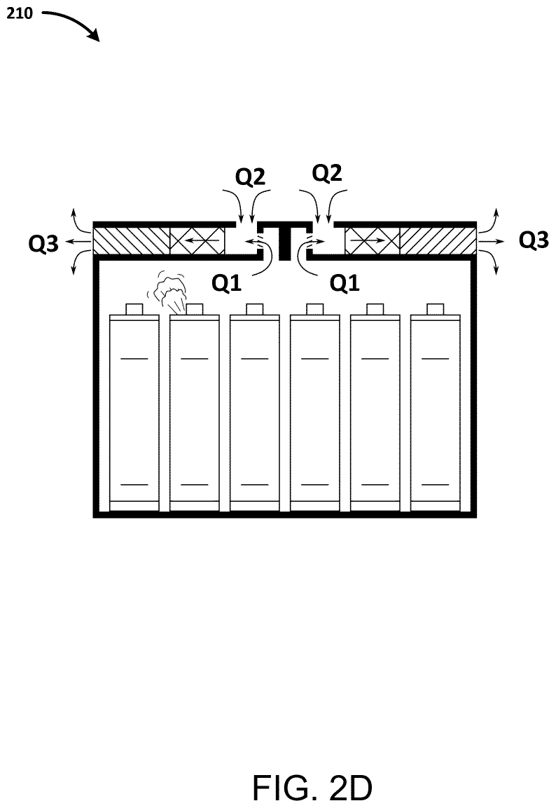

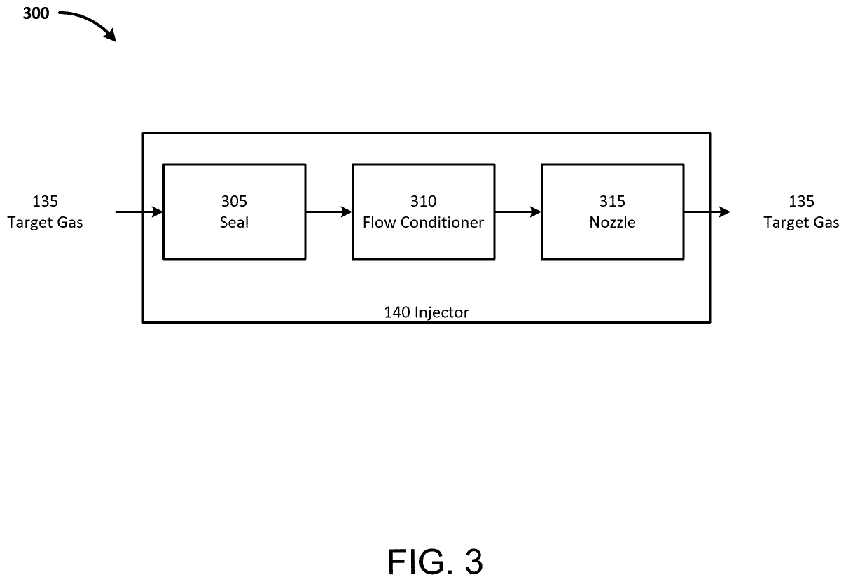

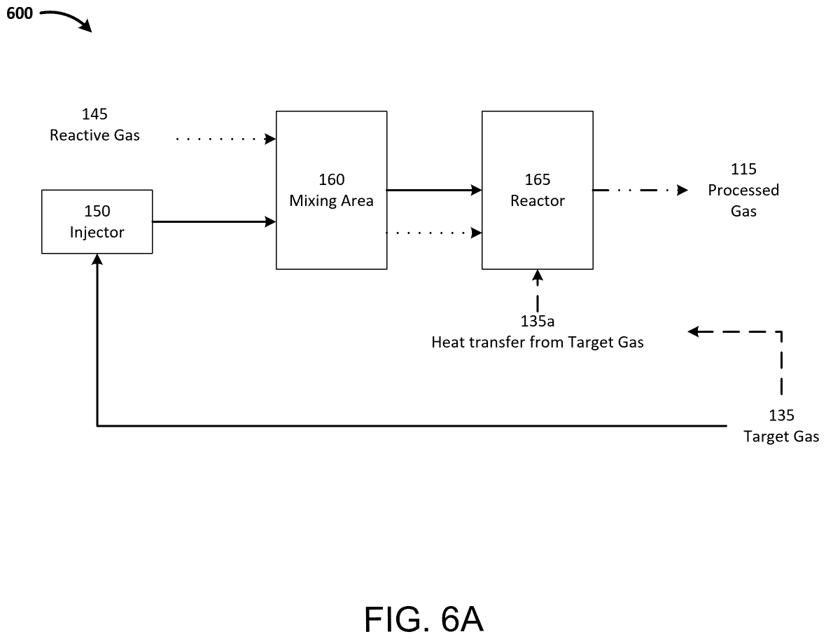

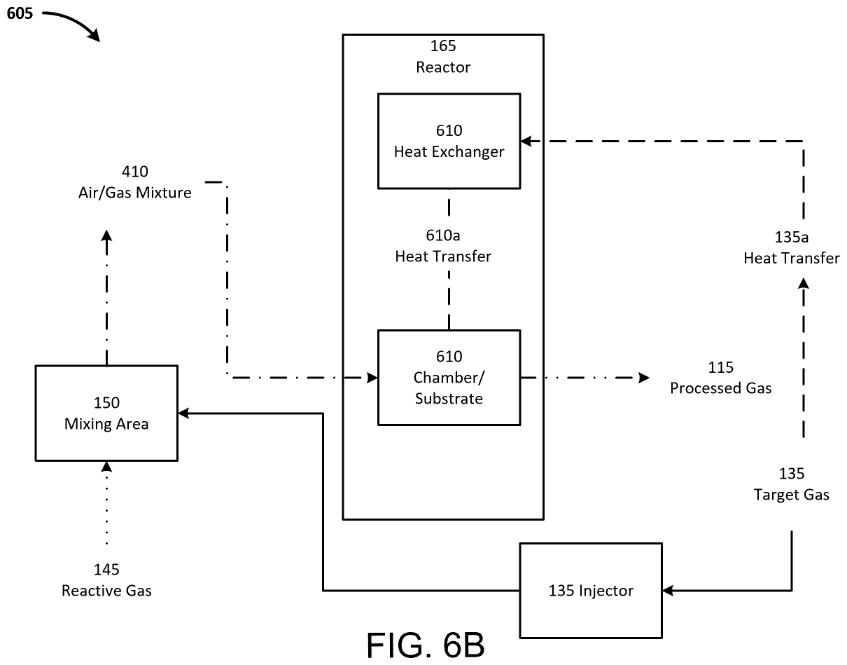

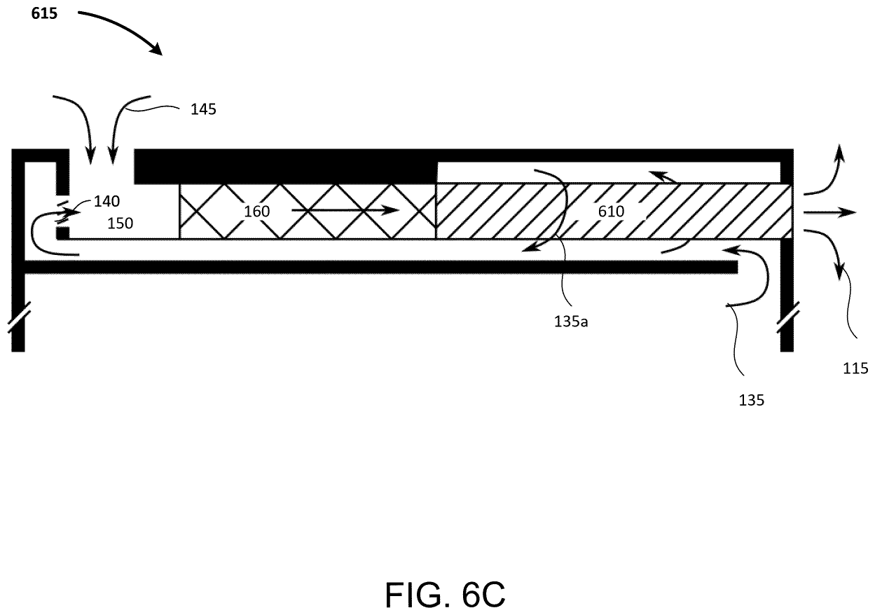

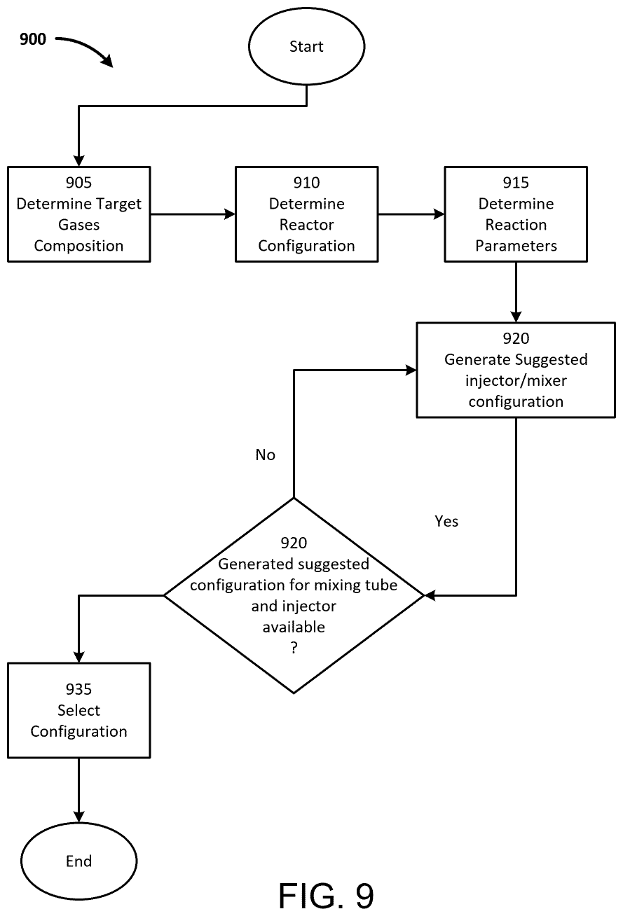

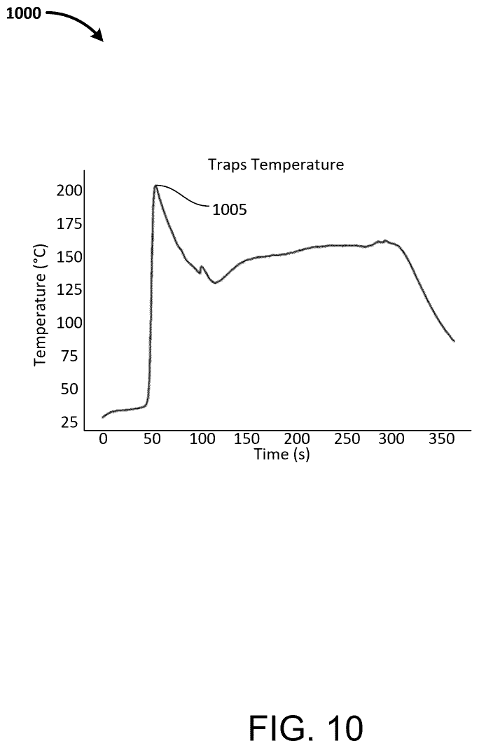

To aid understanding, this document is organized as follows. First, to help introduce discussion of various embodiments, a passive automatic injector reactor (PAIR) system is introduced with reference to FIGS. 1-2D. Second, that introduction leads into a description with reference to FIGS. 3-5E of some exemplary embodiments of the injector system and the mixing area system. Third, with reference to FIGS. 6A-8, some exemplary embodiments of the reactor are described. Fourth, with reference to FIG. 9, the discussion turns to an exemplary method of configurating the PAIR system for a container. Finally, the discussion turns with reference to FIG. 10-13, to discuss some exemplary experimental data concerning the temperature of the reactor, the entrainment flow rate, the container's internal pressure and/or the molar flow rate.

FIG. 1 depicts an exemplary passive fire, explosion, and overpressure mitigation and venting system for batteries PAIR system employed in an illustrative use-case scenario 100. The illustrative use-case scenario 100 includes a user 105. The user 105 is transporting a series of containers 110. The containers 110 are releasing a processed gas 115 to the surrounding air. The processed gas may, for example, be inert. The processed gas may, for example, be non-flammable. The processed gas may, for example, be non-toxic. The user may, for example, be a military personnel member moving a battery container from one end of a warehouse to another end of a warehouse. The user may, for example, be a warehouse worker transporting laptop batteries.

The container 110 contains an energy storage device 120. The energy storage device 120 includes an enclosure 125. The enclosure 125 contains a series of energy storage modules (e.g., batteries 130, as depicted). The enclosure 125 may, for example, become hot and/or not receive cooling.

Over periods, gas released by batteries may, for example, leak. Batteries may, for example, include seals to prevent gas leakage. Batteries may, for example, emit toxic gas when they are overcharged and/or exposed to high temperatures. Batteries may, for example, emit flammable gas when they are overcharged and/or exposed to high temperatures. The batteries may, for example, after reaching certain temperatures, begin to release toxic gases. The batteries may, for example, release flammable gases. For example, as depicted, the series of batteries 130 are leaking a target gas 135. The target gas may, for example, be caused by long storage at high temperatures. The target gas may, for example, be flammable. The target gas may, for example, be toxic.

The target gas 135 is confined within the enclosure 125 such that there is one outlet. The target gas 135 flows to the one outlet through an injector 140. The injector may, for example, include a flow conditioner. By way of example and not limitation, a flow conditioner may include a flapper valve configured to pulsate the target gas (e.g., in response to pressure changes and/or predetermined pressure threshold(s)) to condition (e.g., increase) the flow rate of the target gas Q1 out of the injector. The flowing of the target gas 135 entraps reactive gases 145 such as the surrounding air and oxygen containing fluid. The target gas 135 and the reactive gases 145 (e.g., surrounding air, specific oxygen containing fluid, oxygen source) cross flows at an intersection point 150 of a mixing area 160. The intersection point 150 may, for example, cause a mixing process 150a of the two fluids. The target gas flow is represented by Q1. The reactive gas flow is represented by Q2. The mixture of the two fluid (e.g., air) flows is represented by Q3.

The intersection point 150 causes the two fluid streams to merge into a target gas mixture 155. The target gas mixture 155 is directed further into the mixing area 160. The mixing area may, for example, include a Venturi tube. The mixing area may, for example, include a series of concentric mixing tubes. The series of concentric tubes may, for example, lead to multiple reactors. The mixing area may, for example, a include series of stacked tubes. The mixing tubes may, for example, mix the target gas mixture 155 into a well-mixed target gas air mixture. The well-mixed target gas air mixture flows from the mixing area 160 to the reactor 165.

In the depicted example, the reactor includes a heat exchanger. The heat exchanger may, for example, provide heat to start the catalytic process used to treat the well-mixed target gas air mixture into a processed gas 115. The processed gas may, for example, be inert. The process gas may, for example, be nontoxic. The processed gas may, for example, be non-flammable. A second heat exchanger may, for example, be included to cool the processed gas as it leaks out, so that the gas does not cause fires or burning of the containers.

Embodiments of the present system concept provide an integrated system that mitigates flammable, explosive and/or toxic environments. For example, some implementations may be particularly configured to prevent flammable, explosive, and/or toxic environments caused by battery failures during thermal runaway, by chemically neutralizing toxic species, oxidizing and/or combusting flammable species, and discharging the non-flammable, non-toxic gas species into an area away from the battery. In the following text, the terms “battery,” “energy storage system,” “cell,” and “pack” may be used interchangeably (unless the context indicates otherwise) and may refer to any energy storage module. For example, some implementations may be configured for a specific one or more cell chemistries described herein including, but not limited to, lithium-based battery chemistries. For example, some implementations may be adapted for lithium-ion, lithium-ion polymer, lithium iron phosphate, and/or lithium metal energy storage modules. In some implementations, a PAIR system(s) may be configured for nickel-based cell chemistries (e.g., nickel-metal hydride, nickel cadmium). In some implementations, a PAIR system(s) may be configured for other electrochemical-based energy storage devices.

In some implementations, such as depicted, an injector may, for example, be passive. A passive injector may, for example, not require a user activation. A passive injector may, for example, not require a powered activation (e.g., electrical actuation, electrical control signal). For example, a passive injector may include mechanical mechanism(s) (e.g., Venturi tube, flapper valve, biased valve such as by one or more spring members). For example, the passive injector may automatically operate in response to mechanical inputs (e.g., pressure, absolute pressure, relative pressure such as between a chamber and an external environment, fluid flow such as flow rate, velocity, acceleration).

FIG. 2A is a block diagram depicting an exemplary PAIR system 200. In exemplary PAIR system 200 includes a target gas 135. The target gas 135 is represented by a black line. The target gas 135 fluid flows toward an injector 140. The injector 140 directs the target gas toward a mixing area 160. The flow through the injector increases the flow velocity through a nozzle, which discharges into the inlet of the mixing area or chamber.

The exemplary PAIR system 200 includes a reactive gas 145. The reactive gas 145 is represented by dots. The reactive gas may, for example, include oxygen-containing fluids. The reactive gas may, for example, include the air surrounding the enclosure. The reactive gas 145 flows towards the mixing area 160 due to entrapment caused by the flow of the target gas. The reactive gas 145 and target gas 135 flow together in mixture towards the reactor 165. The reactor chemically reacts 165 with the reactive and target gasses to create a product of a processed gas 154. The processed gas 115 is represented by a line with two dots. The processed gas may, for example, be non-flammable. The processed gas may, for example, include a non-toxic section where oxygen from an external oxygen source (e.g., from the surrounding ambient air), is drawn into the mixing chamber.

These battery and oxygen-containing gas flows then mix in the mixing area prior to entering the reactor where the hazardous gases are chemically neutralized, oxidized, reacted or adsorbed. Various passive mixing methods can be employed in the mixing area and include, but are not limited, to mixing nozzles, pulse jet mixing, swirl mixers, and mixing vanes.

The exemplary PAIR system 200 includes a reactive gas 145. The reactive gas 145 is represented by dots. The reactive gas may, for example, include oxygen-containing fluids. The reactive gas may, for example, include the air surrounding the enclosure. The reactive gas 145 flows towards the mixing area 160 due to entrainment caused by the flow of the target gas. The reactive gas 145 and target gas 135 flow together in mixture towards the reactor 165.

The reactor can be multi-stage and composed of various types of catalytic materials that neutralize, react, and/or oxidize the gases present in the stream. Heat exchangers (Hx) can transfer heat from the reactor to the battery gas stream prior to entering the injector. Heat from gases at the outlet can also be transferred to the surrounding air stream prior to mixing with the battery gases. The heat transfer subsystems provide appropriate thermal conditioning to promote optimal reactions in the reactor. The system is designed for, but is not limited to, an input of various gas mixtures composed of hydrogen, carbon monoxide, carbon dioxide, hydrocarbons, oxygen, nitrogen, argon, hydrogen fluoride, hydrogen chloride, hydrogen cyanide, nitrogen dioxide, sulfur dioxide, and air. The reactor discharges non-flammable and non-toxic gas species products through the outlet away from the battery. The discharge of non-flammable and non-toxic gas species may, for example, advantageously prevent the buildup of flammable gas concentration in the area surrounding the battery to below flammable limits. The reaction and discharge may, for example, reduce the oxygen concentration below a limiting oxygen concentration (LOC). The reaction and discharge may, for example, prevent ignition of a fire, fire spread and/or explosion. The reaction and discharge may, for example, prevent release and/or buildup of toxic gas concentrations, and/or reduce toxic concentrations below permissible exposure limits (PELs).

The reactor chemically reacts 165 with the reactive and target gasses to create a product of a processed gas 154. The processed gas 115 is represented by a line with two dots. The processed gas may, for example, be non-flammable and/or non-toxic. The discharge of non-flammable and non-toxic gas species also reduces toxic species to below PELs. By discharging gases released by a battery in an enclosure, the system also reduces the pressure in the enclosure preventing the enclosure from failing due to overpressure.

The exemplary PAIR system 200 is not limited to the specifics of the representative embodiment or the nature of the application. Although the steps or operations may be presented in a specific order, this order may be changed in different embodiments. In some embodiments, a series of steps shown in this specification can be performed in a single step, simultaneous steps or sequence of steps. The process steps may also be staged in series and/or parallel. Series and/or parallel processing steps may, for example, advantageously enhance entrainment, maximize flow rate, and/or improve performance. The PAIR system may, for example, include several subsystems and/or subcomponents. Such systems and/or components may include, by way of example and not limitation one or more of: injector, flow conditioning system, mixing area, reactor, heat exchanger, and/or exhaust.

FIG. 2B depicts a close up of the exemplary schematic of an exemplary PAIR system as seen in the use-case scenario 100. FIG. 2C depicts an exemplary illustrative scenario of an exemplary PAIR system as seen in the use-case scenario 100. FIG. 2D depicts a plurality of exemplary PAIR systems 210 used in a single enclosure. Multiple PAIR systems may, for example, be used in a single container. A container may, for example, have multiple reactor outlets for the process gas. The container may, for example, include multiple inlets for the surrounding air oxygen-containing fluid.

FIG. 3 is a block diagram 300 depicting an exemplary injector system. The injector contains processes and systems that condition the flow prior to exiting from a nozzle towards the mixing tube. The block diagram 300 includes a target gas 135. The target gas is directed toward a seal 305. The inlet of the injector is sealed such that the inlet is in fluid communication with the headspace in the battery enclosure. The purpose of the seal is to ensure that flammable gases are directed through the injector and do not leak into the surrounding environment.

By way of example, but not in limitation, the seal may include a flapper valve, an umbrella valve, a ball valve, and/or a membrane. The seal may, for example, open when a predetermined pressure in the container is reached. The seal may, for example, open at 15 psi to release gas from the container into the flow conditioner and nozzle. The seal may, for example, open at 20 psi to release gas from the container into the flow conditioner and nozzle. The seal may, for example, open at 25 psi to release gas from the container into the flow conditioner and the nozzle. The seal may, for example, include a one-way Tesla valve.

The seal may, for example, open at 35 psi to release gas from the container into the flow conditioner and the nozzle. The seal 305 is connected to a flow conditioner 310. The flow conditioner may, for example, pulsate the flow to induce entrainment. The flow conditioner may, for example, be a flapper valve that oscillates at predetermined intervals. The flow conditioner may, for example, be a membrane valve that oscillates at predetermined intervals as to pulse the target gas. The flow conditioner may, for example, be an umbrella valve that oscillates at predetermined intervals as to pulse the target gas.

The flow conditioner 310 is connected to a nozzle 315. Flow conditioning systems include but are not limited to filters for processing particulates and toxic species, and pressure sensitive valves or one-way valves for releasing gases in a manner that improves entrainment of the surrounding air. The gases that flow from the injector to the mixing area are discharged with sufficiently high velocity to entrain the surrounding air. The injector may also increase or enhance other fluid dynamics properties, such as turbulence or vorticity, that promote mixing.

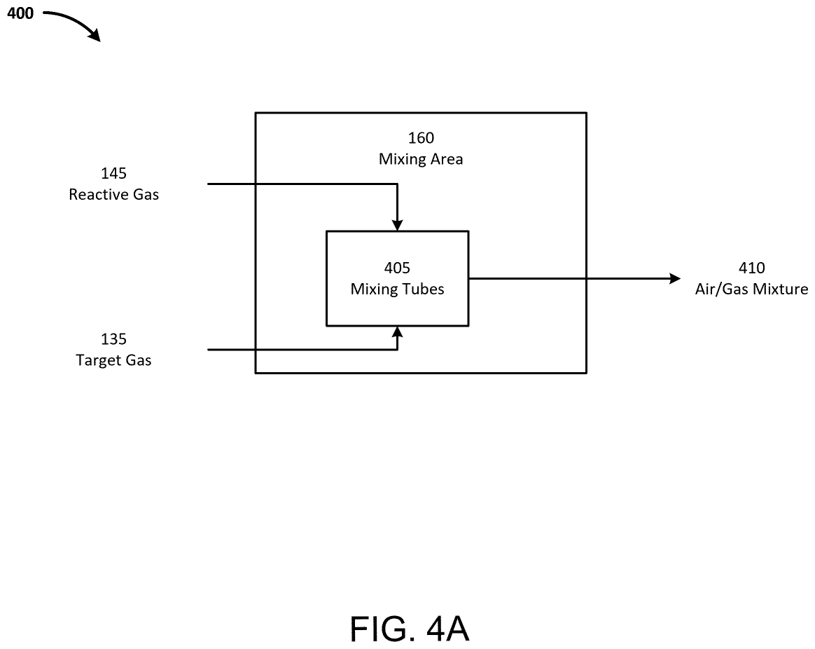

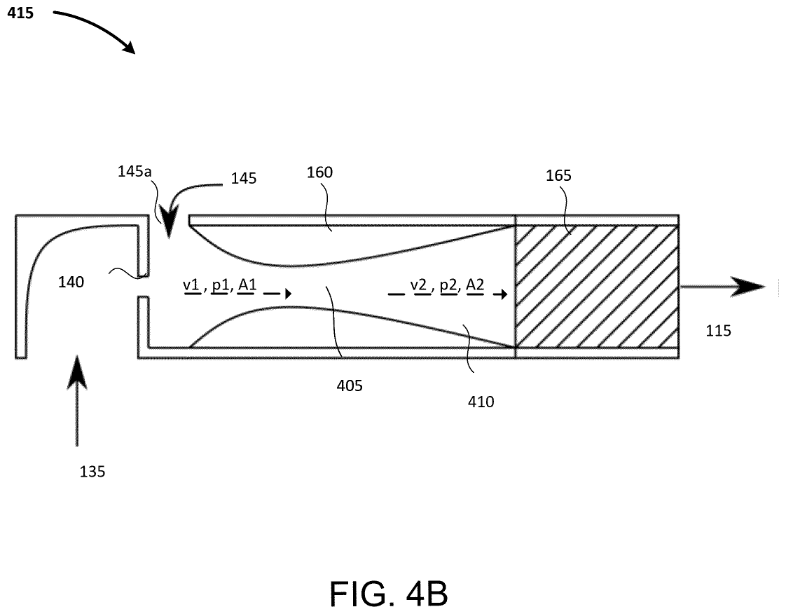

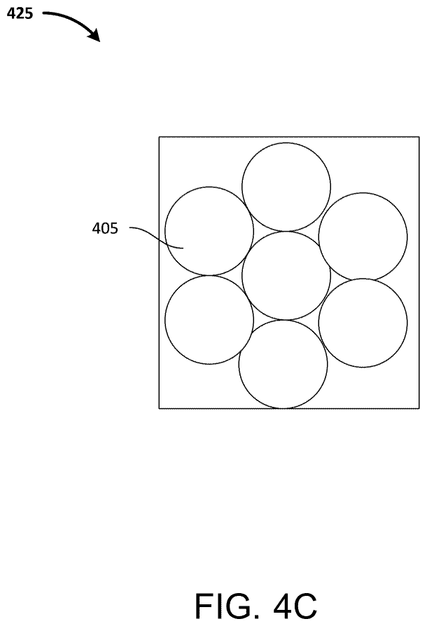

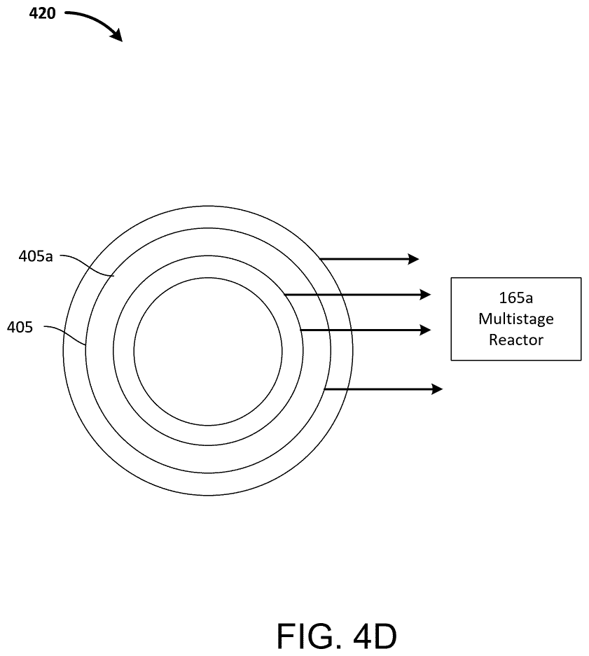

FIG. 4S is an exemplary diagram 400 of the mixing chamber that combines the reactive gas and the target gases. The mixing area 160 includes mixing tubes 405. The mixing tubes mix the reactive gases 145 and the target gases 135 to create an air gas mixture 410. The mixing area can be composed of various geometries to accommodate differing battery architectures as well as to promote optimal mixing of the battery gases and surrounding air. The geometry can be composed of circular, or rectangular tube sections, or arrays of these tube sections. The geometry can vary along the length of the mixing section to promote mixing as well as to condition the flow prior to entering the reactor. Other passive mixing methods include vanes to promote swirl and grids or other passive flow obstructions that enhance turbulence.

Flow conditioning systems include heat exchangers. Heat exchangers may, for example, be configured to preheat a flow stream(s) prior to the reactor section. The mixing chamber may also include a subsystem that supplies additional oxygen stored onboard in the system. The onboard oxygen may include compressed air and/or oxygen (e.g., concentrated) that releases into the mixing chamber. A flow switch and/or thermal switch may be used to automatically open a release valve in the event of a gas release. Additional oxygen may also be introduced into the mixing chamber using a chemical oxygen generator that thermal decomposes potassium chlorate, sodium chlorate, lithium perchlorate, inorganic superoxides, ozonides, other chlorates and perchlorates, or other oxygen-containing compounds. Typical oxygen-containing compounds of these types require heat to release gaseous oxygen. The required heat may be supplied by the hot battery gases themselves, a heat transfer system such as a heat pump that transfers heat from the failed battery, a secondary chemical igniter such as a solid propellant or electrical heating system.

FIG. 4B depicts an exemplary schematic of a mixing area system 415. The mixing area system may, for example, be a venturi tube design used to control the velocity, pressure, and/or density of the gas entering and/or exiting the center apex from an input created from the flows of the target gas and the reactive gas into the system.

In some implementations, the PAIR system can be incorporated onto batteries, battery modules, and/or energy storage systems. For example, the PAIR system may configured to act like a vent that relieves pressure buildup in the primary and/or any secondary enclosure containing cells, battery modules, packs or the battery system(s). For example, the system can be installed on a shipping container that contains batteries, a battery pack in an electric vehicle, or a container housing battery in a warehouse.

FIG. 4C depicts an exemplary stacked mixing tube configuration 425. The mixing tube configuration includes mixing tubes. FIG. 4D depicts an exemplary concentric mixing tube 420 used with a multi-stage reactor. The exemplary concentric mixing tube 420 includes a plurality of concentric mixing tubes 405a. The concentric mixing tubes 405a is connected to a multistage reactor 165a. The multistage reactor may, for example, act as an ignition switch to cause a chain reaction resulting in the reaction. The multistage reactor, may, for example, include multiple outlets for the processed gas.

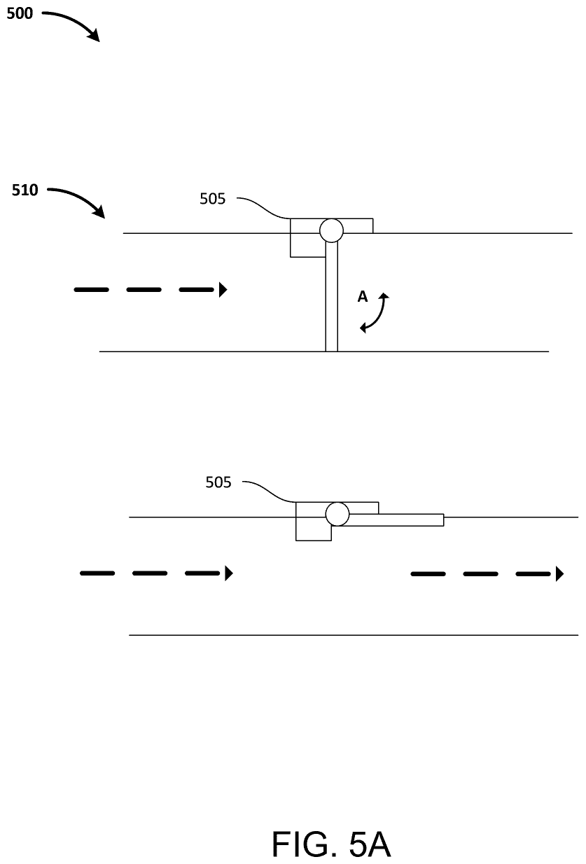

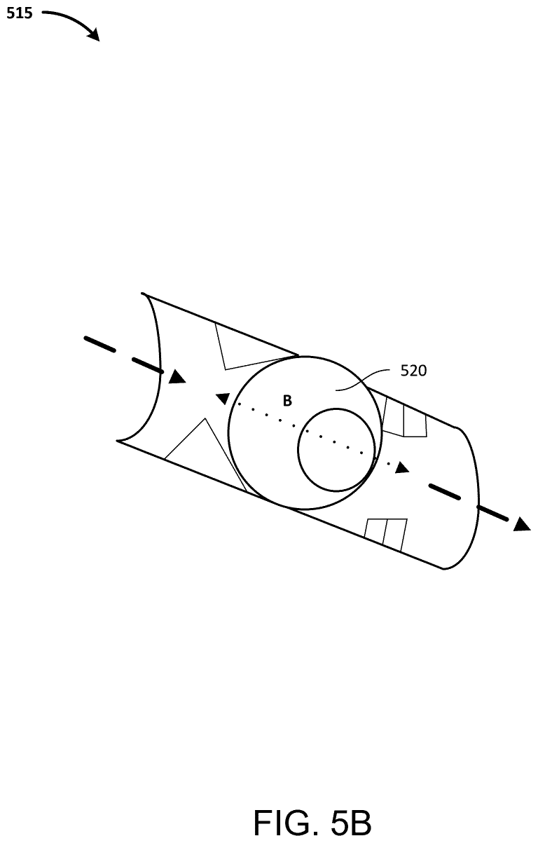

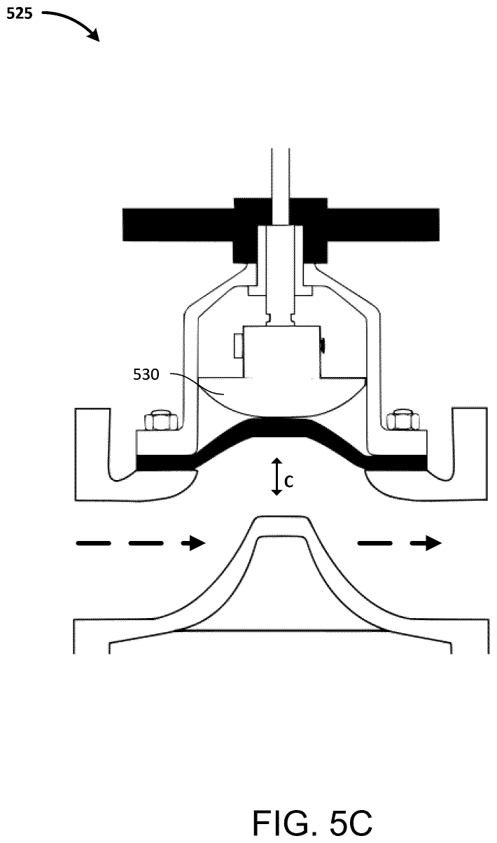

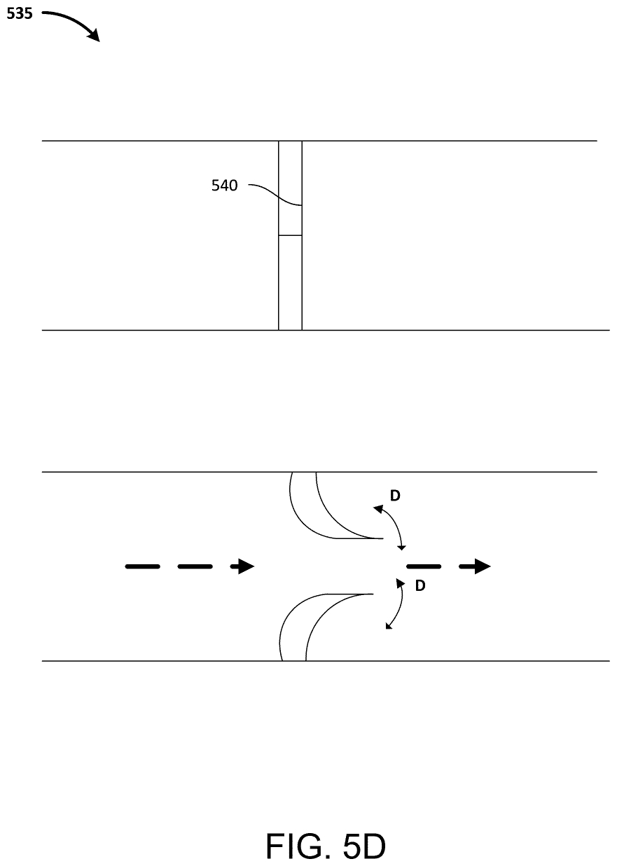

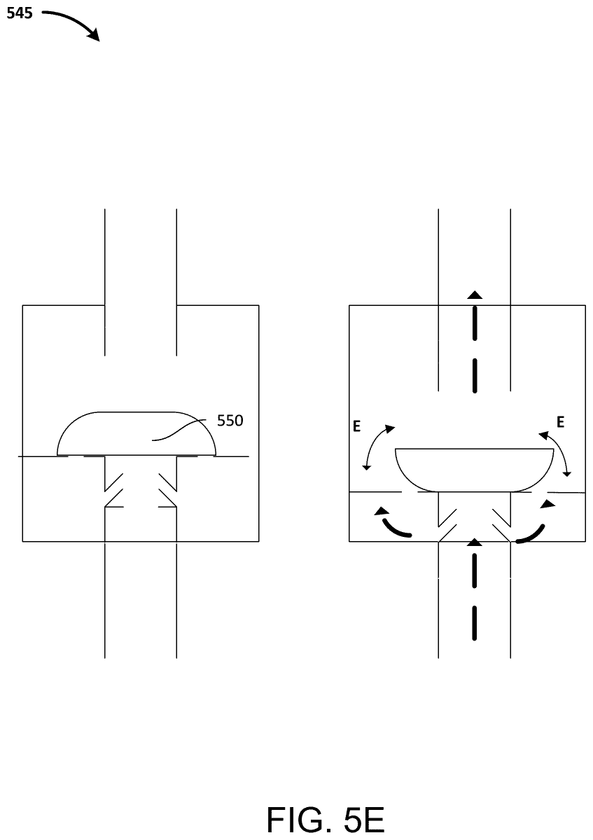

FIG. 5A-5E depict by way of example, but not in limitation, several passive valves that may, for example, be used in the PAIR system. The location of the valves may, for example, be at inlet for the reactive gas, the target gas, inside the mixing chamber, inside the reactor, and at the outlet.

FIG. 5A depicts an exemplary flapper valve schematic 500. The exemplary flapper valve schematic 500 includes a flapper valve 505. The exemplary flapper valve schematic 500 includes a closed flapper valve 510. The closed flapper valve opens as pressure builds at the inlet, such that the inlet may open in a motion A. For example, the flapper valve may be configured to respond (e.g., open, close) at one or more predetermined pressure thresholds. The flapper valve may, for example, have a biasing member (e.g., spring, counterweight). The biasing member may be adjustable such as, for example, to selectively set a predetermined pressure threshold(s). The closed flapper valve 510 transitions in a motion A into an open flapper valve. The flapper valve may, for example, oscillate to pulsate the flow.

FIG. 5B depicts an exemplary ball valve schematic and flow diagram 515. The schematic and flow diagram 515 includes a ball valve 520. The ball valve may, for example, act as a passive seal. The ball may, for example, act as a one way-valve only opening to flows in a specified direction. The ball may, for example, close if the flow is opposite to the opening flow direction.

FIG. 5C depicts an exemplary membrane valve schematic and flow diagram 525. The schematic and flow diagram 525 includes a membrane 530. The membrane may, for example, act as a passive seal. The membrane may, for example, only open at a specified pressure to lift the membrane in a motion C. The membrane may, for example, be made of rubber.

FIG. 5D depicts a second exemplary membrane valve schematic and flow diagram 535. The schematic and flow diagram 535 includes a slit membrane 540. The membrane may, for example, act as a passive seal. The membrane may, for example, only open in one direction. The membrane may, for example, only open at a specified pressure to lift the membrane in a motion D. The membrane may, for example, be made of rubber.

FIG. 5E depicts an exemplary umbrella valve schematic and flow diagram 545. The schematic and flow diagram 545 includes an umbrella valve 550. The umbrella valve may, for example, act as a passive seal. The membrane may, for example, only open in one direction. The membrane may, for example, only open at a specified pressure to lift the membrane in a motion E. The membrane may, for example, be made of rubber.

FIG. 6A depicts an exemplary PAIR system block diagram configuration 600. The reactive gas 145 is shown as a dotted line. The reactive gas 145 is directed toward the mixing area 160. The target gas 135 is directed toward the injector 140. As the target gas 135 passes by the reactor 165, it transfers heat toward the reactor. The heat is used to fuel the catalyst cycle of converting the mixed target air gas into a processed gas 115. The processed gas may, for example, be inert. The heat transfer is depicted by dashed lines. The target gas 135 is directed from the injector 140 to the mixing area 160. The mixed gas from the mixing area 160 are directed toward the reactor. The processed gas may treat the mixed gas from the mixing area 160 into a processed gas. The processed gas 115 is depicted by a dash double dot dash line. The target gas is directed from the injector to the mixing area. The reactive gas and injector gas are directed toward the reactor.

FIG. 6B. depicts an exemplary reactor block diagram of a PAIR system 605 such that the reactor heats up the target gas as it flows from the enclosure to the injector. The exemplary reactor block diagram of a PAIR system 605 diagram of the reactor system shows where hazardous gases are oxidized, reacted, neutralized, and/or converted into non-hazardous gas species. The reactor uses chemical, physical, or physicochemical processes, to oxide, react, neutralize, and/or convert incoming flammable and toxic gases. The reactor may rely on one or multiple processes. In the preferred embodiment, the reactor includes of a porous media substrate coated in catalytic material that promotes oxidation, reaction, neutralization, conversion, and/or adsorption of the hazardous gases. The porous media substrate includes, but is not limited to, ceramic monoliths, ceramic foams, and pellets made of alumina, zirconia, or other suitable ceramic. Metallic foams may also be used. The catalytic material includes, but is not limited to noble metal catalysts, such as Platinum, Gold, Silver, and Palladium, non-noble metallic elements, such as iron, chrome, copper, manganese, and oxides of these elements, and metal organic frameworks (MOFs).

In some embodiments, the reactor is of a catalytic type, the flow reactor inlet flow is sufficiently heated in the upstream mixing region such that the reactor inlet flow temperature is larger than the light-off temperature or minimum temperature required for catalytic activation. The light-off temperature varies depending upon the catalyst material and concentration of hazardous gas species in the incoming gas flow and can range from standard room temperature to 500° C. The heat from exothermic reactions in the reactor may, for example, be used to maintain minimum temperatures required to activate the catalyst material. Heat from the reactor may, for example, be used to pre-heat gases prior to reaching the injector and/or pre-heat gases in the inlet or reactor. Other embodiments include other reactors, such as can combustors, annular combustors, cross flow combustors and porous media combustors. In these embodiments of non-catalytic type, chemical igniters or heat exchangers may be used to initiate combustion reactions.

The exemplary PAIR system 605 includes a target gas 135. The target gas 135 transfer heat by a dashed line heat transfer 135a. The heat transferred 135a is directed toward a heat exchanger 610. The heat exchanger 610 directs the heat toward a heat transfer 610a. The heat transferred 610a is directed to a reaction chamber and or substrate. The air gas mixture 410a is depicted by a dash dot dash line. The PAIR system 605 includes a reactor 165. The reactor 165 includes the heat transfer 610a from the heat exchanger 610. The reactor 165 includes the chamber and/or substrate used to catalyze the target gas mixture into a processed gas.

FIG. 6C depicts an exemplary schematic of a PAIR system 615 such that the reactor heats up the target gas as it flows from the enclosure to the injector. The PAIR system 615 includes a target gas 135. The target gas 135 transfers heat 135a to the reactor 165. The target gas 135 flows to the injector 140. The target gas from the injector 140 flows to the intersection point 150 where the reactive gas 145 flows in. The gases from the intersection point 150 flow to the mixing area 160. The gas from the mixing area flows to the reactor 165. The reactor 165 treats the air gas mixture 410 to create a processed gas 115. The processed gas may, for example, include non-toxic gases. The processed gas may, for example, include non-flammable gases. The processed gas may, for example, include inert gases.

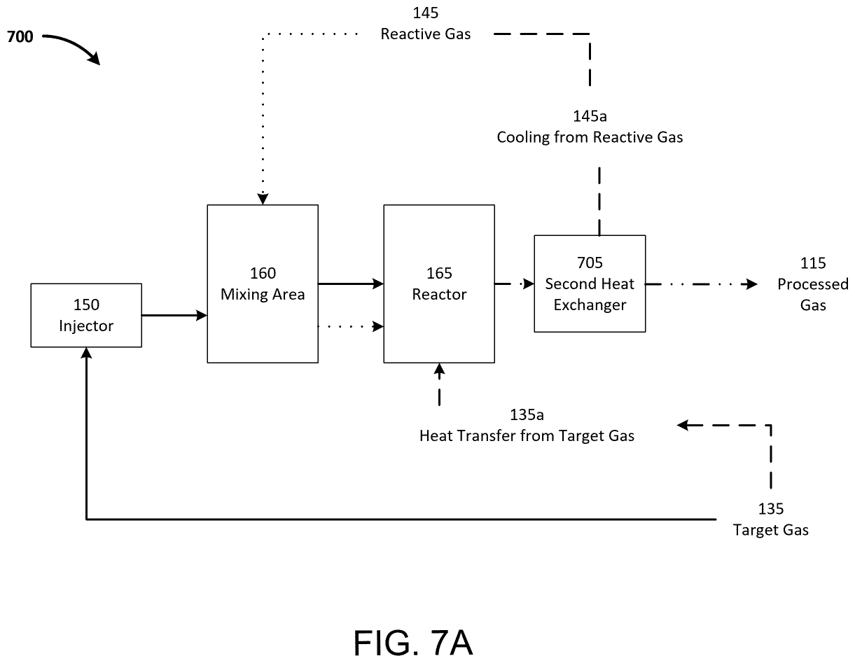

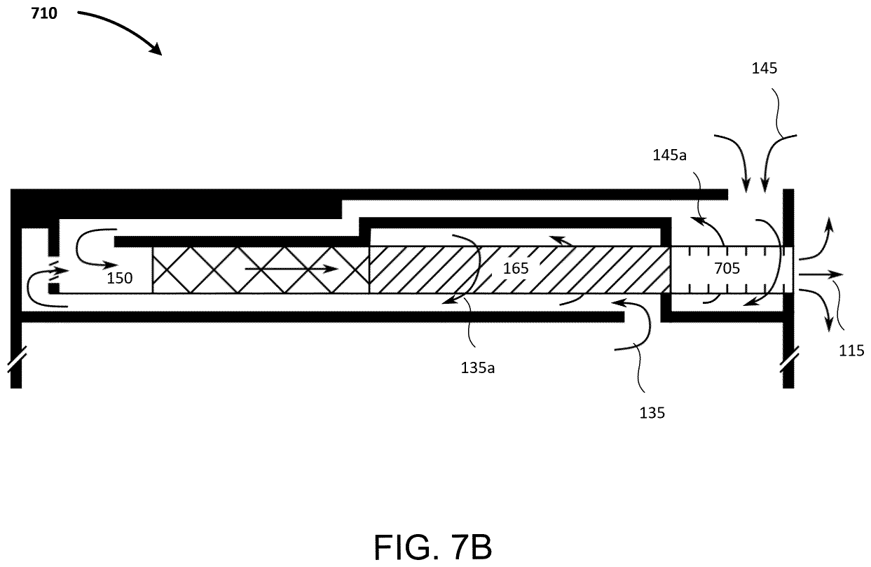

FIG. 7A depicts an exemplary PAIR system block diagram configuration 700 such that the reactive gas cools the reactor as it flows in. The exemplary PAIR system block diagram configuration 700 includes a reactive gas 145. The reactive gas 145 provides cooling from the reactive gas 145a to a second heat exchanger 705. The reactive gas may, for example, swirl around the second heat exchanger before ducting into the mixing area. The second heat exchanger cools the processed gas 115 as it is released, such that the processed gas is not released at high temperatures. FIG. 7B depicts an exemplary schematic 710 of a PAIR system configuration such that the surrounding air cools the reactor as it flows in. The exemplary schematic 710 is an exemplary schematic of the exemplary PAIR system block diagram configuration 700. The heat transfer 135a is represented by the swirling arrows. The cooling from the reactive gas 145a is represented by the swirling arrows.

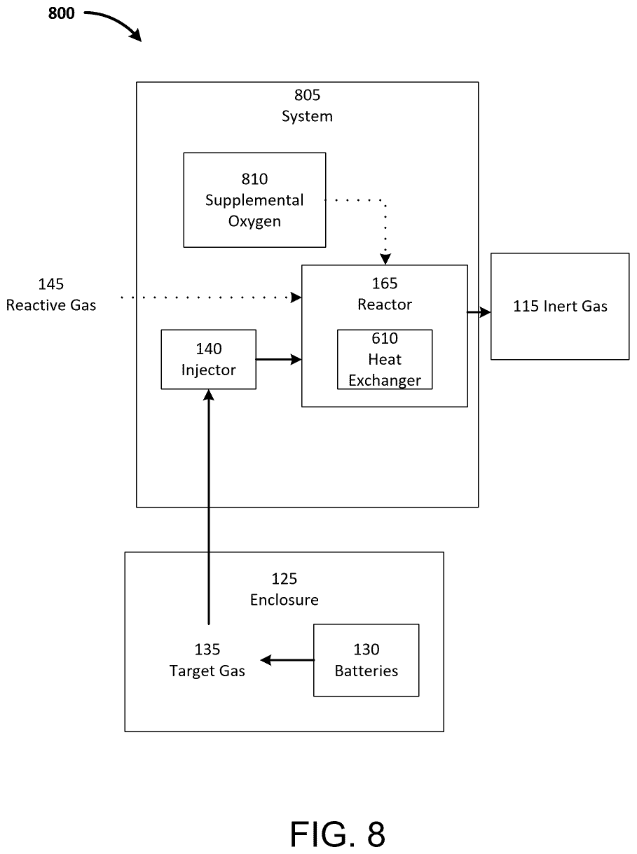

FIG. 8 depicts an exemplary block diagram 800 of a PAIR system with a supplemental oxygen supply configuration. This enclosure could be the primary enclosure for the battery module, pack or rack that contains individual cells and modules, or a secondary enclosure that houses the battery module, pack or rack during battery operation, transport, storage, or warehousing. The system maintains pressure in the enclosure below the maximum design pressure of the enclosure or the safety threshold for overpressure, or desired reduced pressure, by venting gases out of the enclosure interior to the outside. Because the enclosure can maintain internal pressure above ambient, the flow through the system is driven by the higher than ambient pressure evolution in the enclosure resulting from gases released from the battery during failure.

The exemplary block diagram 800 includes an enclosure 125. The enclosure 125 contains batteries 130. The batteries are emitting a target gas 135. The target gas 135 is being directed by the increased pressure in the container to the injector 140. The increased pressure may, for example, be caused by a fixed volume in the enclosure. The pressure may, for example, be modeled with variations of the ideal gas law. The injector 140 directs the target gas to the reactor 165. The reactor includes a heat exchanger 610. Reactive gas 145 is entrained into the reactor 165 by the target gases flow.

The exemplary block diagram 800 includes a system diagram 805. The system diagram 805 includes the injector 140. The system diagram 805 includes the reactor 165. The system diagram 805 includes a supplemental gas container 810. The supplemental gas container may, for example, be pressurized with oxygen. The supplemental gas container may, for example, act as a supplement to the reactive gas from the surrounding air of the enclosure.

FIG. 9 depicts an exemplary method 900 for configuring the PAIR system to passively direct target gas and entrain surrounding air. In step 905, determine the target gas composition. Parameters may, for example, include the target gases flammability, toxicity, reactivity, and/or density. In step 910, determine the reactor for the PAIR system. Factors used to determine the reactor may, for example, include the geometry of the enclosure (length, width, volume, height, material of external walls), the number of reactors, the type of environment the container will be stored in, the amount of every day use the container will have with users. Next, in step 915 determine the reaction parameters. These factors may, for example, include what pressure to start the reaction. These factors may, for example, include the temperature of the enclosure. These factors may, for example, include the maximum flow allowed within the container. These factors may, for example, include the minimum amount of flow necessary to induce entrapment. In step 920, a user and/or a computer processor will generate a suggested injector and mixer configurations based on the inputs of step 905, step 910, and step 915. The user and/or computer processor in step 925 must determine whether the generated suggested injector and configuration is available. If not available, the processor and or user may retrieve an additional optimal configuration to suggest to the user from a data base and/or cloud data base. If available in step 925, the user and/or computer processor would select that PAIR system configuration.

FIG. 10 depicts exemplary data points 1000 with respect to the reactor's temperature over time. shows the reactor temperature evolution of the system during the venting process. The exemplary data points exemplary data points 1000 includes a temperature maximum 1005. The maximum 1005 where the air flow to the reactor was stopped. In larger scale and over longer periods, the temperature may, for example, become much hotter temperatures. The temperature may, for example, reach 500 degrees Celsius. The temperature may, for example, reach 800 degrees Celsius. The temperature may, for example, reach 300 degrees Celsius. The temperature may, for example, vary depending on the configuration of the system. The inlet flow into the reactor includes battery thermal runaway gas species. In this case, preheating of the inlet flow or reactor was not applied. During the catalytic process, flammable gas species are converted to non-flammable gas species. The initial reactants include flammable gas species, namely hydrogen, carbon monoxide, and various hydrocarbons including methane, ethylene, and volatile organic compounds, released from various battery chemistries, most preferably to a lithium ion/polymer cell chemistry and the like. Catalytic reactions or oxidation is a chemical process that can be implemented in the reactor chamber. The reactor chamber may also utilize other chemical processes including porous-media combustion, lean-premixed combustion, common combustion processes or a series of gas-phase or surface reaction processes. The conversion efficiency also varies depending on environmental conditions such as reactor temperature, inlet gas temperature, gas mixture concentrations, humidity and pressure.

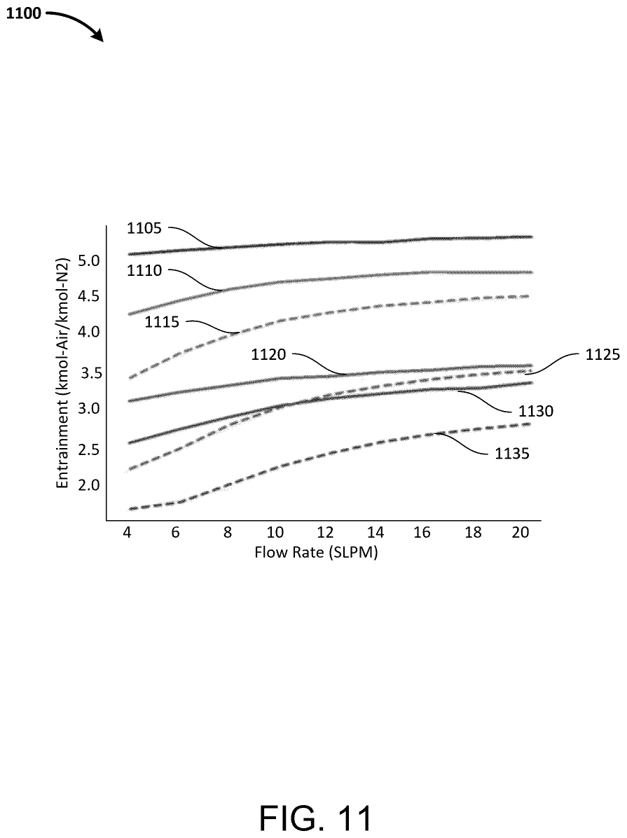

FIG. 11 depicts exemplary data points 1100 that shows the entrainment ratio for various types of injector nozzles and mixing tube designs as a function of venting flow rate. The exemplary data points 1100 includes a data set 1105 from a first nozzle and the first mixing chamber The exemplary data points 1100 includes a data set 1110 from a second nozzle and the first mixing chamber. The exemplary data points 1100 includes a data set 1115 from the first nozzle and a second mixing chamber. The exemplary data points 1120 includes a data set 1105 from a third nozzle and the first mixing chamber. The exemplary data points 1100 includes a data set 1125 from the third nozzle and the second mixing chamber. The exemplary data points 1100 includes a data set 1130 from a fourth nozzle and the first mixing chamber. The exemplary data points 1100 includes a data set 1135 from the fourth nozzle and the second mixing chamber.

The amount and species composition of battery gases released during thermal failure depend on a range of battery characteristics including, but not limited to, battery size, type, geometry, chemistry, form factor, design, state-of-charge, state-of-health, enclosure or casing material, and failure mode. The amount of entrained air or oxygen-containing gas required to completely react, oxidize, and/or process the hazardous gas species may, for example, depend on battery gas release properties. The entrainment ratio may, for example, be configured to be large enough that the available oxygen from the entrained surrounding air can completely react with the gas species present in the battery gas stream. In some embodiments, the nozzle may, for example, be designed to entrain sufficient oxygen such that mixtures of battery gas and oxygen ranging from fuel-lean to stoichiometric are discharged into the reactor. The nozzles may, for example, be configured to provide sufficient oxygen such that the mixture of battery gas and oxygen is slightly fuel-rich as long as the species concentrations in the exhaust gas discharged from the reactor are below flammable and permissible exposure limits.

The system may, for example, include multiple nozzles in parallel, series or combination of both to promote sufficient entrainment of oxygen. The system may also include multiple units each containing a nozzle, mixing, and reactor sections that operate in parallel where the inlet to the unit nozzles are in fluid communication with the headspace in the battery enclosure and the outlet of the reactors are in fluid communication with the air external to the battery enclosure. The system may, for example, operate with multiple units in series, where the inlet of the nozzle in the first unit is fluid communication with the headspace in the battery enclosure, and the exit of the reactor in the first unit is in fluid communication with the inlet of the nozzle in the second unit, and so forth.

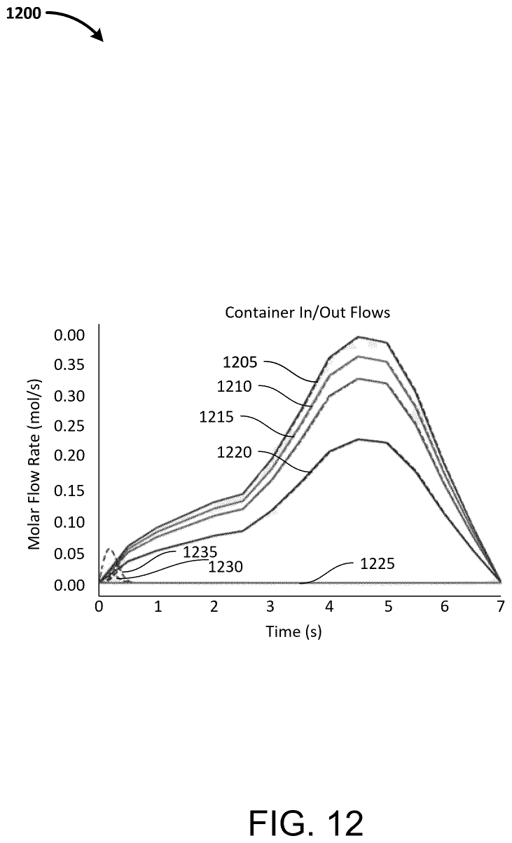

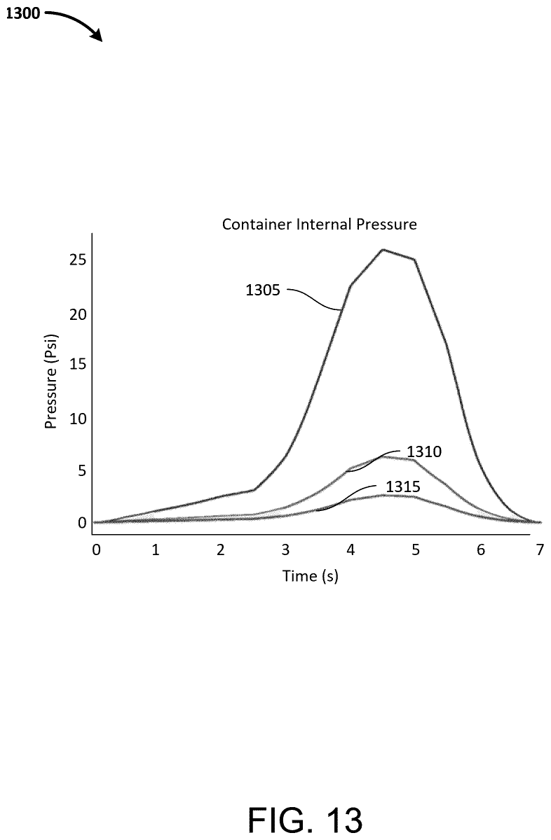

FIG. 12 and FIG. 13 show two charts whose outputs were determined by a thermodynamic, physio-chemical model. The thermodynamic, physio-chemical model simulates the gas release of a 94 Ah, 4.2 V prismatic battery cell into a container with 30% headspace initially containing ambient air (22% oxygen, 78% nitrogen). The release rate and composition is determined by experimental data in the available literature.

FIG. 12 depicts exemplary data points 1200 with respect to the target gas inflow compared to the reactive gases entrained. The exemplary data points 1200 includes a data set 1205 with respect to the gas H2. The exemplary data points 1200 includes a data set 1210 with respect to the gas CO. The exemplary data points 1200 includes a data set 1215 with respect to the gas CO2. The exemplary data points 1200 includes a data set 1220 with respect to the gas O2. The exemplary data points 1200 includes a data set 1225 with respect to water (H2O). The exemplary data points 1200 includes a data set 1230 with respect to the gas N2 being entrained. The exemplary data points 1200 includes a data set 1235 with respect to the gas O2 being entrained.

The exemplary data points 1200 depict the representative molar flow rates for each tracked species into and out of the headspace represented by solid and dashed lines respectively. The dashed lines for nitrogen and oxygen show the displacement of these species early-on in the release process by the battery gases.

FIG. 13 depicts exemplary data points 1300 with respect to the internal pressure of the container. The exemplary data points 1300 includes a data set 1305 with respect to a first design system. The exemplary data points 1300 includes a data set 1310 with respect to a second design system. The exemplary data points 1300 includes a data set 1315 with respect to a third design system.

The exemplary data points 1300 shows the gauge pressure within the headspace for three different system implementations. The model results show the venting effect of different fire protection designs on the internal enclosure pressure. The higher-than-ambient pressure in the enclosure drives battery gases accumulated in the headspace of the container or enclosure through the fire protection system that discharges the gases out of the container or enclosure. The fire protection system is designed such that the maximum internal pressure remains below a prescribed safety threshold for the container or enclosure. Typical thresholds are commonly defined by the pressure required to reach the yield strength, a portion or percentage less than 100% of the yield strength, ultimate tensile strength, or a portion of percentage less than 100% of the ultimate tensile strength of the container or enclosure. Without the venting action of the fire protection system, the pressure in the container or enclosure would exceed the tensile strength of the container resulting in an overpressure failure.

Although various embodiments have been described with reference to the figures, other embodiments are possible. For example, some embodiments may be configured in predetermined configurations. Each predetermined configuration may, for example, be configured for a specific application (e.g., flow parameters, target gas composition(s), geometries, volumes, battery types). A user may, for example, select a predetermined configuration for a specific application (e.g., ‘off-the-shelf’).

In some implementations, a PAIRS may, for example, be modular. For example, a PAIRS may be assembled from one or more custom and/or predetermined injectors, mixing chambers/mixing areas, and/or reactors. A modular system may, for example, advantageously enable a PAIRS to be built from readily available components to suit a specific application (e.g., a specific battery type, a specific enclosure type and/or geometry).

For example, a PAIRS may be manufactured (e.g., assembled, formed) as a unitary structure. The unitary structure may, for example, include a housing. The housing may, for example, include (e.g., as components, as integrated) at least one injector and at least one mixing chamber/mixing area. The housing may, for example, include a reactor(s). The housing may, for example, be configured to be mechanically coupled to (e.g., supported by) an energy storage container.

In some implementations, for example, a PAIRS may be reusable (e.g., used repeatedly for a single enclosure, removable and re-attachable across multiple enclosures).

In some implementations, a PAIRS may be disposable. For example, an entire PAIRS may be disposable. In some implementations, for example, a component(s) (e.g., reactor(s)) of the PAIRS may be disposable.

In some implementations, for example, a PAIRS may be provided with a self-attachment mechanism. For example, the injector may be coupled (e.g., mechanically) to a self-piercing and/or self-drilling mechanism. Such an implementation may, for example, allow rapid and/or inexpensive coupling to containers (e.g., cargo containers, cardboard boxes, plastic bins, cargo trailers). In some implementations, an injector may be coupled (e.g., mechanically) with a self-attaching (e.g., cam-activated, screw-on) mechanism to couple the PAIRS to an existing aperture into a container.

In some implementations, for example, a battery may be configured to include the housing (e.g., as an add-on component, as integrated into the battery housing). In some implementations, an energy load configured to hold an energy storage module(s) may, for example, be provided with a PAIRS. As an illustrative example, a computing device (e.g., laptop) may be provided with at least one PAIRS. The PAIRS may be fluidly coupled to a battery enclosure, for example, and be vented to the outside. Such embodiments may, for example advantageously prevent fire, explosion, and/or toxic gas release. In some implementations, for example, a miniaturized PAIRS may be coupled to a smartphone. Such embodiments may, for example, advantageously prevent explosion and injury such as has been previously experienced by consumers.

In some implementations, by way of example and not limitation, a sensor(s) may be coupled to a PAIRS. For example, a pressure sensor may be attached to an injector. The injector may operate (e.g., mechanically) in response to a sensor (e.g., mechanical input from a sensor). In some implementations, for example, a PAIRS may be in an inactive state (e.g., locked valve, sealed membrane) until a signal (e.g., mechanical, electrical) is received. Upon receiving a (predetermined) signal, the PAIRS may be operated into an active state (e.g., valve unlocked, membrane pierced). In the active state, the PAIRS may passively automatically inject target gas into a mixing chamber for entrainment with reactive fluid prior to entering a reactive chamber.

Although an exemplary system has been described with reference to FIG. 1-13, other implementations may be deployed in other industrial, scientific, medical, commercial, and/or residential applications. The PAIR system may, for example, be used by the military to move battery powered device from a point A to a point B in preparedness drills. The PAIR system may, for example, be used by warehouse workers to safely transport battery goods. The PAIR system may, for example, be used in long transatlantic and/or pacific journeys for shipping containers of batteries.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a mixing device may, for example, include a mixing chamber (e.g., 160) in fluid communication with an oxygen source (e.g., 145). The mixing device may, for example, include a passive injector (e.g., 140). The passive injector may, for example, include an inlet in fluid communication with an energy storage enclosure (e.g., 125) containing at least one target gas (135). The passive injector may, for example, include an outlet in fluid communication with an inlet of the mixing chamber. The passive injector and the mixing chamber may, for example, include configurations such that, in response to the at least one target gas exceeding a predetermined pressure threshold, the passive injector may, for example, then automatically and passively creates a fluid stream (Q1) of the at least one target gas into the mixing chamber. In response to the at least one target gas exceeding a predetermined pressure threshold, the mixing chamber may, for example, entrain oxygen-containing fluid (Q2) from the oxygen source and mixes it into the fluid stream. In response to the at least one target gas exceeding a predetermined pressure threshold, the mixed fluid stream may, for example, be delivered into a reactor chamber (165) configured to induce at least one predetermined chemical reaction in a presence of the at least one target gas and oxygen in the oxygen-containing fluid. The mixing chamber and the passive injector may, for example, be mechanically coupled to and supported by the energy storage enclosure such that the at least one target gas exits the energy storage enclosure through the passive injector.

In an illustrative aspect, the mixing device includes a the mixing chamber that may, for example, include a Venturi that mixes the fluid stream of the at least one target gas and the oxygen-containing fluid.

In an illustrative aspect, the mixing device includes the passive injector that may, for example, include a valve configured such that the valve automatically operates between an open mode and a shut mode, as a function of the predetermined pressure threshold, such that the at least one target gas is pulsed into the mixing chamber.

In an illustrative aspect, the mixing device includes the passive injector that may, for example, include a plurality of injectors configured such that the plurality of injectors delivers the at least one target gas to a plurality of mixing areas that deliver the mixed fluid stream to a plurality of reactors.

In an illustrative aspect, the mixing device that may, for example, further include a multistage reactor wherein the mixing tubes are configured such that the mixing tubes deliver the mixed fluid stream in stages to the reactor such that the reactor begins the predetermined chemical reactions in stages.

In an illustrative aspect, the mixing device may, for example, further include a heat exchanger such that the heat exchanger may transfer heat to the reactor chamber such that a catalytic chemical process starts to neutralize the mixed fluid stream and transform the mixed fluid stream into a processed gas.

In an illustrative aspect, the mixing device includes the at least one target gas that may, for example, first contact a surface area of a second heat exchanger used as the at least one target gas flows to a mixing chamber such that the at least one target gas transfers heat to the reactor before entering the mixing chamber.

In an illustrative aspect, the mixing device may, for example, further include a second heat exchanger such that the oxygen-containing fluid first contacts a surface area of the second heat exchanger as the oxygen-containing fluid flows to a mixing chamber such that the oxygen-containing fluid cools the heat exchanger before entering the mixing chamber, wherein the second heat exchanger cools a processed gas as the processed gas leaves the second heat exchanger.

In an illustrative aspect, the mixing device that includes the oxygen-containing fluid may, for example, include a surrounding air fluid surrounding the energy storage container.

In an illustrative aspect, a mixing device may, for example, include a mixing chamber (160) in fluid communication with a reactive gas source (145). The mixing device may, for example, include a passive injector (140). The passive injector may, for example, include an inlet in fluid communication with an energy storage enclosure (125) containing at least one target gas (135). The passive injector may, for example, include an outlet in fluid communication with an inlet of the mixing chamber. The passive injector and the mixing chamber may, for example, be configured such that, in response to the at least one target gas exceeding a predetermined pressure threshold, then the passive injector automatically and passively creates a fluid stream (Q1) of the at least one target gas into the mixing chamber. In response to the at least one target gas exceeding a predetermined pressure threshold, the mixing chamber entrains at least one reactive gas (Q2) from the reactive gas source and mixes it into the fluid stream. In response to the at least one target gas exceeding a predetermined pressure threshold, the mixed fluid stream is delivered into a reactor chamber (165) configured to induce at least one predetermined chemical reaction in a presence of the at least one target gas and the at least one reactive gas.

In an illustrative aspect, the mixing device that includes the at least one reactive gas comprises oxygen.

In an illustrative aspect, the mixing device includes a mixing chamber that may, for example, include a Venturi that mixes the fluid stream of the at least one target gas and the reactive fluid.

In an illustrative aspect, the mixing device that includes the passive injector may, for example, include a valve configured such that the valve automatically operates between an open mode and a shut mode, as a function of the predetermined pressure threshold, such that the at least one target gas is pulsed into the mixing chamber.

In an illustrative aspect, the mixing device may, for example, further include mixing tubes configured such that the mixing tube form a stacked pattern in the mixing chamber.

In an illustrative aspect, the mixing device, may, for example, further include a multistage reactor wherein the mixing tubes are configured such that the mixing tubes deliver the mixed fluid stream in stages to the reactor such that the reactor begins the predetermined chemical reactions in stages.

In an illustrative aspect, the mixing device may, for example, further include a supplemental oxygen container configured such that the at least one reactive gas comprises oxygen from the supplemental oxygen container.

In an illustrative aspect, the mixing device may, for example, further include a heat exchanger such that the heat exchanger may transfer heat to the reactor chamber such that a catalytic chemical process starts to neutralize the mixed fluid stream and transform the mixed fluid stream into a processed gas.

In an illustrative aspect, the mixing device that includes the at least one target gas may, for example, first contact a surface area of a second heat exchanger used as the at least one target gas flows to a mixing chamber such that the at least one target gas transfers heat to the reactor before entering the mixing chamber.

In an illustrative aspect, the mixing may, for example, further include a second heat exchanger such that the reactive fluid first contacts a surface area of the second heat exchanger as the oxygen-containing fluid flows to a mixing chamber such that the oxygen-containing fluid cools the heat exchanger before entering the mixing chamber, wherein the second heat exchanger cools a processed gas as the processed gas leaves the second heat exchanger.

In an illustrative aspect, the mixing device that includes the mixing chamber and the passive injector may, for example, be coupled together into a unitary structure, and the unitary structure is mechanically coupled to and supported by the energy storage enclosure such that the at least one target gas exits the energy storage enclosure through the passive injector.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A mixing device comprising:
a mixing chamber (160) in fluid communication with an oxygen source (145); and,
a passive injector (140) comprising:
an inlet in fluid communication with a battery enclosure (125) containing at least one target gas (135); and,
an outlet in fluid communication with an inlet of the mixing chamber,
wherein the passive injector and the mixing chamber are configured such that, in response to the at least one target gas exceeding a predetermined pressure threshold, then:
the passive injector automatically and passively creates a fluid stream (Q1) of the at least one target gas into the mixing chamber,
the mixing chamber entrains oxygen-containing fluid (Q2) from the oxygen source and mixes it into the fluid stream,
the mixed fluid stream is delivered into a reactor chamber (165) configured to induce at least one predetermined chemical reaction in a presence of the at least one target gas and oxygen in the oxygen-containing fluid,
wherein the mixing chamber and the passive injector are mechanically coupled to and supported by the battery enclosure such that the at least one target gas exits the battery enclosure through the passive injector.

2. The mixing device of claim 1, wherein the mixing chamber is a Venturi that mixes the fluid stream of the at least one target gas and the oxygen-containing fluid.

3. The mixing device of claim 1, wherein the passive injector comprises a valve configured such that the valve automatically operates between an open mode and a shut mode, as a function of the predetermined pressure threshold, such that the at least one target gas is pulsed into the mixing chamber.

4. The mixing device of claim 1, wherein the passive injector comprises a plurality of injectors configured such that the plurality of injectors delivers the at least one target gas to a plurality of mixing areas that deliver the mixed fluid stream to a plurality of reactors.

5. The mixing device of claim 4, further comprising a multistage reactor wherein the mixing tubes are configured such that the mixing tubes deliver the mixed fluid stream in stages to the reactor such that the reactor begins the predetermined chemical reactions in stages.

6. The mixing device of claim 1, further comprising a heat exchanger such that the heat exchanger may transfer heat to the reactor chamber such that a catalytic chemical process starts to neutralize the mixed fluid stream and transform the mixed fluid stream into a processed gas.

7. The mixing device of claim 6, wherein the at least one target gas first contacts a surface area of a second heat exchanger used as the at least one target gas flows to a mixing chamber such that the at least one target gas transfers heat to the reactor before entering the mixing chamber.

8. The mixing device of claim 7, further comprising a second heat exchanger such that the oxygen-containing fluid first contacts a surface area of the second heat exchanger as the oxygen-containing fluid flows to a mixing chamber such that the oxygen-containing fluid cools the heat exchanger before entering the mixing chamber, wherein the second heat exchanger cools a processed gas as the processed gas leaves the second heat exchanger.

9. The mixing device of claim 1, wherein the oxygen-containing fluid comprises a surrounding air fluid surrounding the battery container.

10. A mixing device comprising:
a mixing chamber (160) in fluid communication with a reactive gas source (145); and,
a passive injector (140) comprising:
an inlet in fluid communication with an electrochemical cell enclosure (125) containing at least one target gas (135); and,
an outlet in fluid communication with an inlet of the mixing chamber,
wherein the passive injector and the mixing chamber are configured such that, in response to the at least one target gas exceeding a predetermined pressure threshold, then:
the passive injector automatically and passively creates a fluid stream (Q1) of the at least one target gas into the mixing chamber,
the mixing chamber entrains at least one reactive gas (Q2) from the reactive gas source and mixes it into the fluid stream, and
the mixed fluid stream is delivered into a reactor chamber (165) configured to induce at least one predetermined chemical reaction in a presence of the at least one target gas and the at least one reactive gas.

11. The mixing device of claim 10, wherein the at least one reactive gas comprises oxygen.

12. The mixing device of claim 10, wherein the mixing chamber is a Venturi that mixes the fluid stream of the at least one target gas and the reactive fluid.

13. The mixing device of claim 11, wherein the passive injector comprises a valve configured such that the valve automatically operates between an open mode and a shut mode, as a function of the predetermined pressure threshold, such that the at least one target gas is pulsed into the mixing chamber.

14. The mixing device of claim 12, further comprising mixing tubes configured such that the mixing tube form a stacked pattern in the mixing chamber.

15. The mixing device of claim 14, further comprising a multistage reactor wherein the mixing tubes are configured such that the mixing tubes deliver the mixed fluid stream in stages to the reactor such that the reactor begins the predetermined chemical reactions in stages.

16. The mixing device of claim 10, further comprising a supplemental oxygen container configured such that the at least one reactive gas comprises oxygen from the supplemental oxygen container.

17. The mixing device of claim 10, further comprising a heat exchanger such that the heat exchanger may transfer heat to the reactor chamber such that a catalytic chemical process starts to neutralize the mixed fluid stream and transform the mixed fluid stream into a processed gas.

18. The mixing device of claim 17, wherein the at least one target gas first contacts a surface area of a second heat exchanger used as the at least one target gas flows to a mixing chamber such that the at least one target gas transfers heat to the reactor before entering the mixing chamber.

19. The mixing device of claim 17, further comprising a second heat exchanger such that the reactive fluid first contacts a surface area of the second heat exchanger as the oxygen-containing fluid flows to a mixing chamber such that the oxygen-containing fluid cools the heat exchanger before entering the mixing chamber, wherein the second heat exchanger cools a processed gas as the processed gas leaves the second heat exchanger.

20. The mixing device of claim 10, wherein the mixing chamber and the passive injector are coupled together into a unitary structure, and the unitary structure is mechanically coupled to and supported by the electrochemical cell enclosure such that the at least one target gas exits the electrochemical cell enclosure through the passive injector.
